(19) United States
(12) Patent Application Publication
(10) Pub. No.: US 2017/0340510 A1
(43) Pub. Date: Nov. 30, 2017

(54) MASSAGE AND MUSCLE RELEASE TOOL

(71) Applicant: Body Iron LLC, Howell, MI (US)

(72) Inventors: Justin W. Spewock, Howell, MI (US); Kenan Wollborg, Inkster, MI (US)

(21) Appl. No.: 15/604,498

(22) Filed: May 24, 2017

Related U.S. Application Data
(60) Provisional application No. 62/340,810, filed on May 24, 2016.

(51) Int. Cl. A61H 7/00

(52) U.S. Cl. CPC A61H 7/003; A61H 2201/0153

(57) ABSTRACT

A massage and muscle release tool having a base having four sides divided into two adjacent pairs of sides with the sides of each pair being of equal length. Each of the sides arms are joined by a corner defining a front and back corner and opposed side corners. A handle extends from the base. There are a plurality of rounded protrusions protruding from the bottom and the protrusions, corners, sides and handle can all be used to manipulate muscles in various ways to alleviate adverse physical conditions.

### RELATED APPLICATIONS

This application claims the benefit of U.S. Provisional Application No. 62/340,810 filed on May 24, 2016.

### STATEMENT REGARDING FEDERALLY SPONSORED RESEARCH NONE

### TECHNICAL FIELD

The tool of the present invention is an ergonomically advanced massage, muscle manipulation and trigger point release designed tool to maximize control and application of pressure to muscles at various points of the body to counter act the negative ergonomic impact of sitting, stiffness or soreness from injury, accident, athletic competition and exercise of all types. This invention relates generally to massage tools and more particularly to a versatile massage tool that is particularly suited for the release of the muscles in all areas of the body including but not limited to in and around the chest, ribs, hip and thigh area.

### BACKGROUND OF THE INVENTION

It is desirable to provide a versatile easy to use massage tool that is particularly adapted to release the chest, hips and leg muscles and related adjacent muscles, but also other muscles of the body to counter act the negative egonomic impact to the body from excessive sitting, exercise, repetitive motion, injury, accident, athletic competition or exercise in general. Contracted muscles of any part of the body including but not limited to the chest and adjacent muscles, hips, shoulders, pec, pec minor, sub scap, seratis and others are what lead to degenerative impact to the bone structure and subsequent nervous system and put the person at higher risk of injury due to a lack of balance between the four quadrants of the body structure. Lack of balance from front and back as well as balanced left and right is a leading cause of back problems in people. The use of computers and sitting hunched over for long periods of time under stress can cause the chest to contract and tighten. Over time this adversely effects posture and creates back, neck, structural and anatomical issues. By releasing these and other muscles, the body and the chest are permitted to move and more fully expand; thus, relieving excessive tightness, muscular knots, tension, stuck energy points, trigger points, ropey band of muscles identified by a jump sign or other issues; allows the body to relax into a structural homeostasis between the left and right and front and back plains of the body. It also helps to improve overall posture, improves breathing which leads to better oxygenation, and physical manipulation of injured or contracted muscles to improve lymph and blood circulation.

As will be appreciated, trigger points set up in muscles that are chronically short. Fixing them can correct postural asymmetries. Trigger points will often inhibit antagonistic muscles. By releasing trigger points, one can help activate the muscles that are inhibited in chronic pain situations such as the muscles of the core and thighs. Common chronic conditions such as low back pain, knee pain, and shoulder pain may be effectively treated by releasing trigger points in the biomechanical chain. More times than not, they are not located at the site of the pain.

An effective trigger point release tool can save time and money by allowing individuals to initiate treatment at home for common musculoskeletal problems.

Although there are a multitude of massage devices available today, none are specifically suited for releasing all aspects of the body to counter act the negative ergonomic impact of sitting—the chest, hips, etc and is suited for the general use in releasing other contracted muscles in the body with an appropriately and ergonomically advanced designed tool. The tool of the present invention facilitates the release of trigger points, facia, lactic acid and provides overall improved lymph and blood circulation. The present invention provides more control over the application of pressure, varied points of pressure, and broad or pointed application. The tool includes an ergonomic handle and multiple hold points to allow the user to exert more effective and accurate pressure than known massage or muscular release tools through its unique winged shape allowing for hand and thumb hold structure that allows for better and more articulate arm and upper body pressure on the device to effectively massage, release, activate and or stimulate the muscles, lymph and or nervous system.

Some examples of known massage tools are the rolling type, for example a ball, such as a lacrosse or tennis ball or foam rollers. The present invention provides a more advanced and well-articulated targeted intervention with the muscle, nervous and lymph system. Lacrosse balls are difficult to control and don't permit a broad brush of the muscle, nor specific release of muscles on a targeted and precise manual basis—one would have difficulty using a hand held ball to release muscles; and rollers are a broad brush that cannot reach specific areas or exert pressure in an articulated manner and are ineffective on the chest, shoulders, lats, sub scap, pec minor, pec major for example to release specific knotted areas, facia, trigger points, and the like.

Graston devices are also well known for massaging muscles. These devices are a modification of traditional hands-on soft tissue mobilization. Graston devices are specifically designed instruments to allow the therapist to introduce a controlled amount of microtrauma into an area of excessive scar and/or soft tissue fibrosis. The hope is that this will invoke an inflammatory response that will augment the healing process. It is also intended to reduce the stress on the therapist's hands. This method is limited in application area and it is more micro focused in its application.

### SUMMARY OF THE INVENTION

The tool of the present invention has a unique pattern of individual knobs across the bottom of the tool, knife edges on the sides and in one embodiment a chisel edge on the front column of the handle, columns and corners that can be used to release specific trigger points, and a unique wing shape that allows for a rolling motion with torque or torsion of the device to enhance precise pressure of the product. The tool is specifically designed for working out various muscle groups, facia and all aspects of the musculoskeletal system as a whole or in specificity, while also being able to be brushed firmly over any muscle such as the pectoralis major or other large muscle groups to comb the muscle fibers and or achieve a nervous system and or sensory release achieved through nerve stimulation by the knobbed bottom/platform of the massage tool.

Other muscles in this area are also benefitted from the use of the multiple knobs, including the subclavis, scapulae, serratus and trapezius muscles and would include but not be limited to the larger muscles of the legs including quadriceps, hamstrings and calves. Additionally, the intercostal muscle of the rib cage can be massaged as well on a broad surface stroke of the base plate. Hips and legs can also be massaged with the tool as well as other muscle groups. Manipulation of the tool is through an ergonomically designed handle and winged structure that provides for more effective self-use and for targeted and precise use by another on someone else.

It should be noted that the tool can be used as a nervous system stimulant or nervous system activation tool for any part of the body or any muscle group. The sensory stimulation is achieved by combing the knobbed bottom of the device along any part of the body to achieve a sensory stimulation or release of tension, flexion or trigger point.

The unique handle structure provides ergonomically optimized control, maneuverability and manual use of the tool in all directions from front to back, side to side with a unique thumb on wing hold allowing for enhanced maneuverability of the device, rolling left or right, nose down or heal down.

The muscle release and massage tool of the present invention fills the gap between foam rollers and balls on a macro level and the Graston device on the micro level by providing a tool that not only allows various pointed contacts with trigger points: but a trigger point to broad based brush application due to the geometric kite/iron pattern of the device and associated knobs. The kite/iron pattern of the base with protruding knobs allows pointed application to brushing application of the muscles; knife edge brushing and focused line contact with muscles through the use of the edges of the kite and more round line contact with the front and back cylindrical columns and the specifically edged front column of the handle structure on the front or pointed end of the device. Overall, the muscle release and massage tool of the present invention offers broader and more extensive point and combing contact than any other message tool and with a more effective ergonomic control that is easy on the hands of the user.

Lastly, human hands get tired. The present invention provides an ergonomically designed handle to enable maximum control and application with minimum effort. And, the human hand lacks the handle, knob or dimple pattern available on the kite/iron surface and are limited as to the force needed to massage key body parts., etc. The present invention overcomes these problems with more effective application and less degenerative impact to the hand by way of allowing a more ergonomically advanced way to rake, rub, trigger point release, massage, striate, elongate, release, stimulate, nervous system stimulate, relax and vasculate the body.

Overall, the device of the present invention fills the space between Graston and rollers or lacrosse balls on the continuum of tools and is more ergonomically functional than the human hand and offers an extension of the hand without the fatigue associated with hand massaging. The present invention provides targeted use over foam rollers, more articulate use than a lacrosse or tennis ball, more nimble use than back bars or stick type devices. The present invention also allows for combing release of muscles similar to Graston but with a broader more comprehensive surface all in an ergonomic structure to provide varying pressure levels to adjust to the body with the ability to comb out constricted, contracted areas of the body as a result of bad ergonomics, repetitive use, exercise and athletic performance, dance, or movement of any type.

In general terms, this invention provides a unique handheld muscle release and massage tool to provide therapeutic pressure on specific points of the body for the release of body muscles, stimulation of nerves and circulation of all types. The device is used to massage specific muscles in specific ways to release contracted muscle fibers, also known as knots or trigger points, to release lactic acid, relieve pain, loosen tense tight muscles, improve circulation and improve mobility and posture and sensory stimulate nerves in order to prompt a relaxation response. The present invention is particularly useful in the chest, legs and hip area, but is also useful on other muscle groups.

The massage tool of the present invention includes a pattern of rounded protuberances, or knobs protruding from the bottom of a base plate that provide a grooming effect to the muscle. These knobs engage the muscle and pressure release through pointed pressure and then separate the muscle fibers through a combing motion. The massage tool is versatile in that it can use a single knob on the pointed end for smaller muscles or a three knob structure on the wide end for larger muscles. The base plate is arched front to back and side to side so as to allow for a rolling planning or radial movement or sweeping, swiping or wiping, rolling motion so as to wick or brush the muscles, nerves, circulatory and lymph systems. The pointed end can be used for specific knots, knifing or trigger points in large and small muscles. The multiple knobs on the bottom provide striations for large and small muscles to be released and separated so as to relax the muscles, stimulate the nerves to release and promote better circulation

The massage tool of the present invention and the associated knobs are particularly well suited to release the chest and rib, hips and leg muscles as well as all muscles of the body. The individual knobs can be used to release specific trigger points in the pectoralis major and minor, while also being able to be brushed firmly over the pectoralis major to comb the muscle fibers. Other muscles in this area are also benefitted from the use of the multiple knobs, including the subclavis, scapulae, serratus and trapezius muscles. The intercostal muscle of the rib cage can be massaged as well on a broad surface stroke of the plate by way of unique rolling, wiping, wicking or rotational use of the invention by way of grabbing the handle, placing a thumb on the wing and rotating the surface away form oneself. The hips, quadriceps, hamstrings, and calves are also ideal for massaging, triggering, stimulating and activating with the present tool.

The massage tool of the present invention provides a broader targeted surface capability than a hand, a graston or roller and has better ergonomics than a lacrosse or tennis ball. Plus the device can be used on ones self or it can be used on another person with more precision than a hand or untrained hand, a lacrosse or tennis ball, or a roller for example and provides a broader brush with more versatility than the Graston and at a much lower cost.

The kite design of the base plate also provides a knife edge of different lengths on the four sides of the base and rounded surfaces at the four angles of the kite shape with three different angles for additional massaging of the muscles. The knife edges provide two long rounded surfaces for massaging across a larger muscle group, and two smaller rounded knife-like edges for smaller muscles. The rounded knife edges can be combed or brushed across the muscle to massage and release trigger points, lactic acid, and relax the muscle, also referred to as combing the muscle. The rounded triangles provide surfaces to attack specific trigger points in the muscles. The kite geometric shape provides three different angles for massaging the muscles and the ability to rotate the muscle release/massage tool to reach any desired location. The tool reaches muscles on the left and right of the body, by turning the tool with the handle and the three different angles, the massage tool can be used for deep tissue massaging for the release of trigger points.

The muscle release/massage tool of the present includes an ergonomic handle for firm grip and allows the massage tool to be used for pointed movements, flat movements and heal and toe movements to address a variety of skeletal muscular issues.

The base plate is rounded to provide a rocking motion to improve gliding along muscles, tendons, muscle bodies and provides a front to back motion that starts with pointed release and then finishes with a striation finish with the three nob butt of the bottom surface. This is unigue to this device and the market as a whole. It achieves trigger point release followed by a rubbing out/wiping out/wicking out of the triggered area.

Strategically placed nobs on the bottom of the base plate provide for striation and separation of muscles, use between ribs, which provides a unique pressure release pattern for muscles and the release of intercostals, trigger points and muscle relaxation, striation and separation to improve blood flow and muscle contraction release.

Knobbed end columns or barrel ends with or with out edge provide additional messaging options, knifing function, trigger release function, such as flat rubbing of muscles, as well as targeted and trigger release of the muscles.

The kite geometric shape provides a pointed and triangle end plate for release of scalene, pectoralis and intercostal under the collar bone and into the arm pit, along the ribs, sub scapulae and lats. It is uniquely designed to maximize a winnowing motion on the muscles to maximize release, release of contraction, lactic acid and increase circulation. This product is an effective instrument for Trigger Point Release, administration of Active Release Technique and or Neuromuscular Release

The handle allows for more controlled manipulation by a user and in the disclosed embodiment, a flat surface on the top of the handle allows the tool to be placed on the floor or against a wall for laying or leaning on the device to release muscles and to apply massage pressure to the feet, for example.

These and other features and advantages of this invention will become more apparent to those skilled in the art from the detailed description of a preferred embodiment. The drawings that accompany the detailed description are described below for those in the mobility, physical therapy, neromusclular release, energy work and deep tissue and Reiki massage areas.

### BRIEF DESCRIPTION OF THE DRAWINGS

FIG. 1 is a perspective view of the massage and muscle release tool of the present invention as viewed from the bottom.

FIG. 2 is a perspective view of the massage and muscle release tool of the present invention as viewed from the top.

FIG. 3 is a top view of the massage and muscle release tool of the present invention.

FIG. 4 is a side view of the massage and muscle release tool of the present invention.

FIG. 5 is an end view of the massage and muscle release tool of the present invention.

FIG. 6 is a bottom view of the massage and muscle release tool of the present invention.

FIG. 7 is a perspective view of a further embodiment of the massage and muscle release tool of the present invention.

### DETAILED DESCRIPTION OF A PREFERRED EMBODIMENT

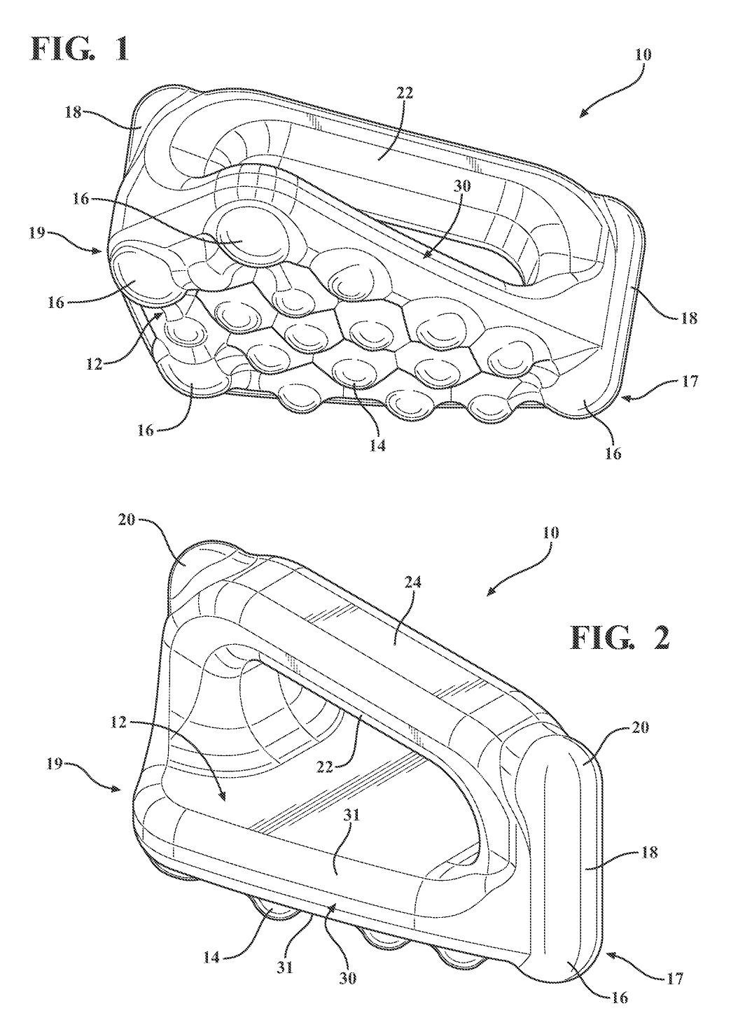

The muscle release and massage tool of the present invention is generally shown at 10 in FIG. 1. The massage tool 10 has a generally kite shaped base plate 12 with four sides 15 (see FIGS. 3 and 6) divided into two adjacent pairs of sides with the sides of each pair being of equal length. The base 12 has protrusions or knobs 14 protruding from the base plate 12. These knobs 14 are generally rounded. Larger knobs 16 are provided at the four corners of the base plate 12.

The massage tool 10 includes a specific pre-defined pattern of rounded protuberances, or knobs 14 and 16 protruding from the bottom of a base plate 12 that provide a point contact and grooming or brushing effect to the muscle. These knobs 14 and 16 engage the muscle and pressure release through pointed pressure and then separate the muscle fibers through a combing motion. The massage tool 10 is versatile in that it can use a single knob 16 on the pointed end 17 for smaller muscles or a three knob 16 structure on the wide end 19 for larger muscles and a unique front to back planing motion that trigger release with the front point and then wipes, striates, neurostimulates with the wide back end when used in a planning or rocking motion from front to back with the device. The pointed end 17 can be used for specific knots or trigger points in large muscles. The multiple knobs 16 on the wide end or a combination of all knobs 14 and 16 on the bottom provide striations for large and small muscles to be released and separated so as to relax the muscle.

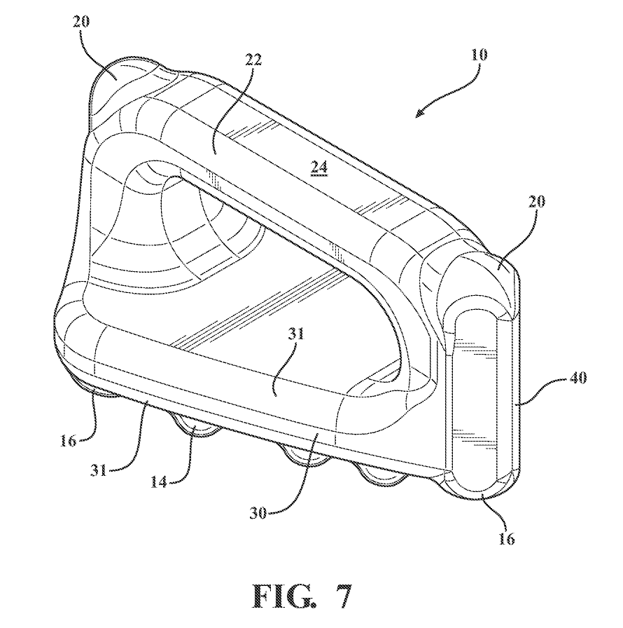

The kite design of the base plate 12 also provides a knife edge 30 of different lengths on the four sides of the base and rounded surfaces at the four angles 32 of the kite shape with four different angles for additional massaging of the muscles. The knife edges are formed by the angled relief surfaces 31 extending from the top and bottom of the base 12. The knife edges 30 provide two long rounded surfaces 34 for massaging across a larger muscle group, and two smaller rounded knife-like edges 36 for smaller muscles. The rounded knife edges 30 can be combed or brushed across the muscle to massage and release trigger points, lactic acid, and relax the muscle, also referred to as combing the muscle. The pointed front chisel edge 40 (see FIG. 7) can be used to trigger, pressure point, active release, knife, separate and striate in a variety of directions and methodologies. The rounded angles 34 provide surfaces to attack specific trigger points in the muscles. The kite geometric shape provides four different angles 32 for massaging the muscles and the ability to rotate the massage tool to reach any desired location. The tool 10 can reach muscles on the left and right of the body, by turning the tool 10. With the handle 22 and the four different angles 32, the massage tool 10 can be used for deep tissue massaging for the release of trigger points.

The base plate 12 is curved to form a slightly convex bottom surface from the opposed sides 29 and front 17 to back 19. In this way, the tool 10 can be rocked upon a muscle group to massage the muscle group in four different directions with varying degrees and angles. It also facilitates the brushing of the tool 10 across a muscle group. The curve extends from the pointed end 17 to the broad end 19 and from opposed sides 29. Stated another way, the base plate is rounded to provide a rocking motion to improve gliding, wicking, neurostimulating along muscles, tendons, muscle bodies, nerves and provides a front to back motion that starts with pointed release and then finishes with a striation finish with the three nob butt or broad end or back 19 of the bottom surface.

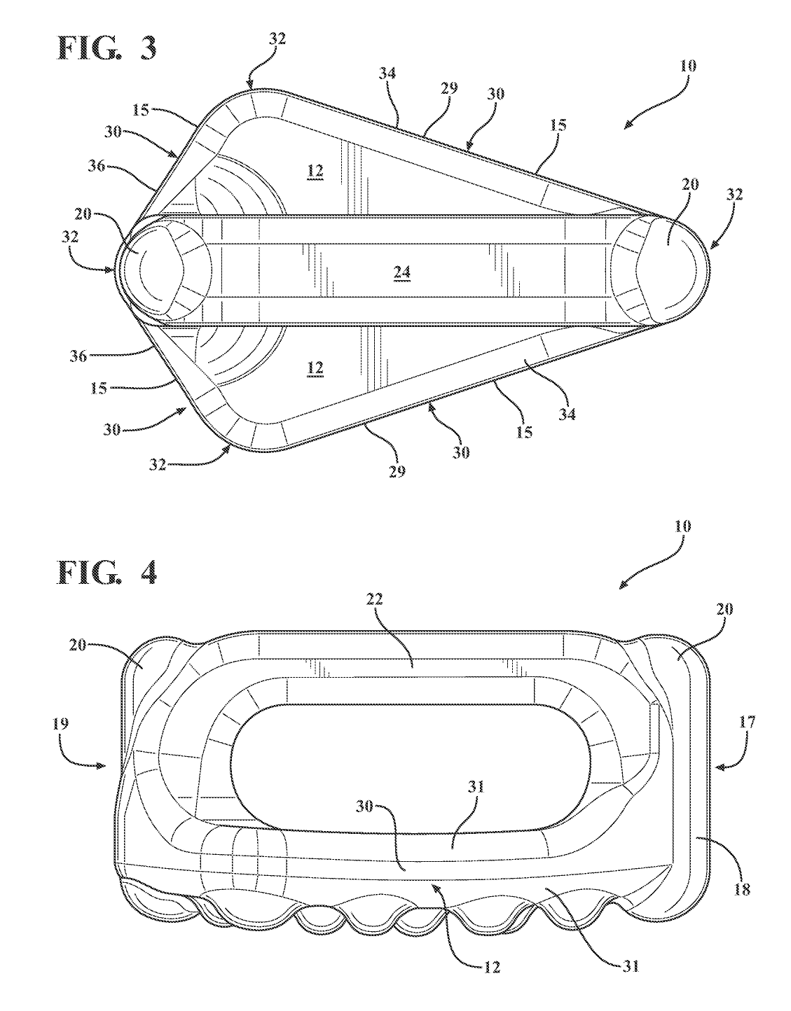

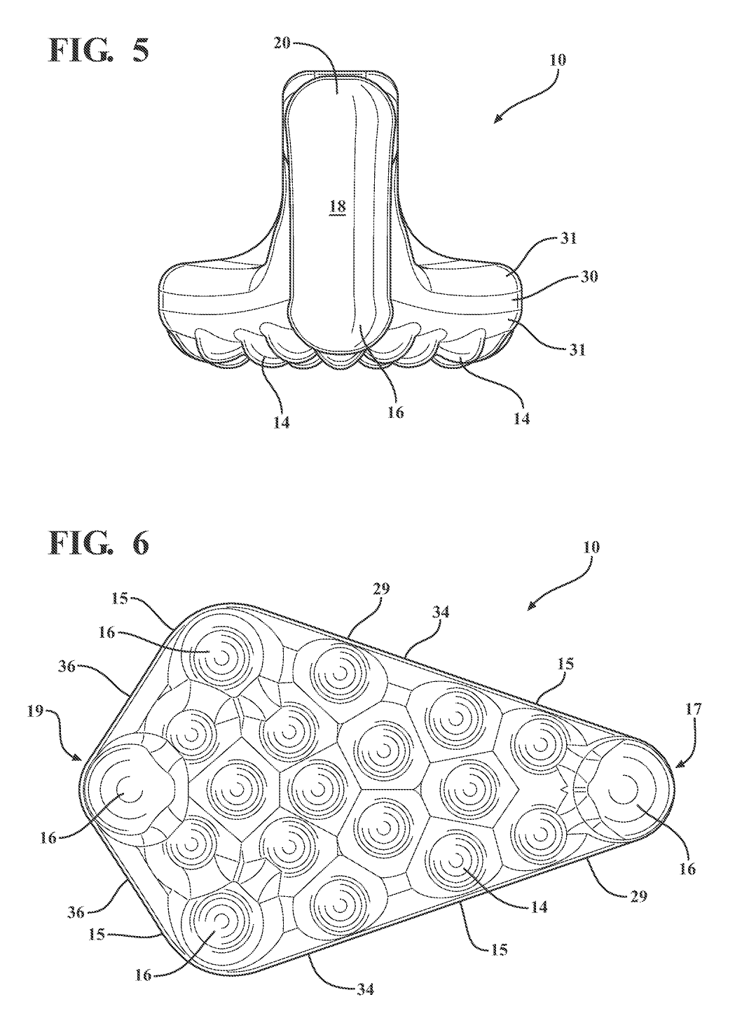

In the embodiment illustrated in FIGS. 1 through 6, the front end 17 and back end 19 of the tool 10 includes columns or barrels 18 that have facing rounded surfaces. Each of these columns 18 are topped with a rounded protrusion 20. A handle 22 interconnects the columns 18. The columns 18 and the handle 22 define an open space so that the handle 22 can be grasped for use of the tool 10. Knobbed end columns or barrel ends 18 provide additional messaging options, such as flat rubbing of muscles with the rounded surfaces of the columns 18, as well as targeted and trigger release of the muscles through the use of the protrusions 20.

The handle 22 of the disclosed embodiment has a flat upper surface 24. The flat upper surface allows the tool 10 to be positioned on a floor or wall for use in massaging hard to reach areas. The handle 22 allows for more controlled manipulation by a user and in the disclosed embodiment, the flat surface 24 on the top of the handle 22 allows the tool 10 to be placed on the floor or against a wall for laying or leaning on the device to release muscles and to apply massage pressure to the feet or back, for example.

Tool 10 provides a unique handheld massage tool to provide therapeutic pressure on specific points of the body for the release of body muscles. The device is used to massage specific muscles in specific ways to release contracted muscle fibers, also known as knots or trigger points, to release lactic acid, relieve pain, loosen tense tight muscles, improve circulation and improve mobility and posture. The present invention is particularly useful in the chest area, but is also useful on other muscle groups.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A massage and muscle release tool comprising:
a base having a top, bottom and four sides divided into two adjacent pairs of sides with the sides of each pair being of equal length; each of said sides being joined by a corner defining a front and back corner and opposed side corners;
a handle extending from said top;
a plurality of rounded protrusions protruding from said bottom;
said bottom surface being arched, having a convex curvature between said front and back corners and between said opposed side corners;
whereby said protrusions, corners, sides and handle can be used to manipulate muscles in various ways to alleviate adverse physical conditions.

2. The massage and muscle release tool of claim 1, wherein said opposed side corners are rounded.

3. The massage and muscle release tool of claim 1, wherein said at least one of said opposed side corners is rounded and at least one of said opposed side corners has a knife-like edge.

4. The massage and muscle release tool of claim 1, wherein said four sides each have a knife edge defined by angled relief surfaces extending from said top and bottom.

5. The massage and muscle release tool of claim 1, wherein said front and back corners are defined by elongated columns, said columns forming the ends of said handle, said columns having an outwardly protruding semi-circular face.

6. The massage and muscle release tool of claim 5, wherein said columns have opposed rounded end surfaces.

7. The massage and muscle release tool of claim 1, wherein said front and back corners are defined by elongated columns, said columns forming the ends of said handle, one of said columns having an outwardly protruding semi-circular face, the other of said columns having an elongated knife edge.

8. The massage and muscle release tool of claim 7, wherein said columns have opposed rounded end surfaces with the front column having an edged front portion.

9. The massage and muscle release tool of claim 1, wherein said base has wing surfaces adjacent said opposed side corners, said wing surfaces forming pressure application surfaces for precise application of pressure to the human body.

10. The massage and muscle release tool of claim 1, wherein said handle has a flat upper elongated face that allows said massage tool to be positioned and rest upon said handle whereby said bottom can become said top.

11. A massage and muscle release tool comprising:
a base having a top, bottom and four sides divided into two adjacent pairs of sides with the sides of each pair being of equal length; each of said sides being joined by a corner defining a front and back corner and opposed side corners;
a handle extending from said top;
a plurality of rounded protrusions protruding from said bottom;
said four sides each have a knife edge defined by angled relief surfaces extending from said top and bottom;
whereby said protrusions, corners, sides and handle can be used to manipulate muscles in various ways to alleviate adverse physical conditions.

12. The massage and muscle release tool of claim 11, wherein said opposed side corners are rounded.

13. The massage and muscle release tool of claim 11, wherein said at least one of said opposed side corners is rounded and at least one of said opposed side corners has a knife-like edge.

14. The massage and muscle release tool of claim 11, wherein said front and back corners are defined by elongated columns, said columns forming the ends of said handle, said columns having an outwardly protruding semi-circular face.

15. The massage and muscle release tool of claim 14, wherein said columns have opposed rounded end surfaces.

16. The massage and muscle release tool of claim 11, wherein said front and back corners are defined by elongated columns, said columns forming the ends of said handle, one of said columns having an outwardly protruding semi-circular face, the other of said columns having an elongated knife edge.

17. The massage and muscle release tool of claim 16, wherein said columns have opposed rounded end surfaces.

18. The massage and muscle release tool of claim 11, wherein said base has wing surfaces adjacent said opposed side corners, said wing surfaces forming pressure application surfaces for precise application of pressure to the human body.

19. The massage and muscle release tool of claim 1, wherein said handle has a flat upper elongated face that allows said massage tool to be positioned and rest upon said handle whereby said bottom can become said top.

20. The massage and muscle release tool of claim 19, wherein said bottom surface is arched, having a convex curvature between said front and back corners and between said opposed side corners.
